(19) United States
(12) Patent Application Publication
(10) Pub. No.: US 2025/0337808 A1
(43) Pub. Date: Oct. 30, 2025

(54) ADAPTIVE THROTTLING OF STORAGE SERVICE TRAFFIC WITHIN A CLIENT APPLICATION

(71) Applicant: Oracle International Corporation, Redwood Shores, CA (US)

(72) Inventors: Nirvik Basak, Pune (IN); Anantha Kiran Kandukuri, Zürich (CH); Kiran K. Mehta, Pune (IN); Cagri Balkesen, Zürich (CH); Ashish Padiyar, Bangalore (IN); Nitin Kunal, Fallanden (CH); Nipun Agarwal, Saratoga, CA (US); Rajesh Kumar Sivasankarapanickar, Bangalore (IN)

(73) Assignee: Oracle International Corporation, Redwood Shores, CA (US)

(21) Appl. No.: 18/651,611

(22) Filed: Apr. 30, 2024

(51) Int. Cl. H04L 67/1097; H04L 67/1001; H04L 67/1012

(52) U.S. Cl. CPC H04L 67/1097; H04L 67/10015; H04L 67/1012

(57) ABSTRACT

A computer program product, system, and computer implemented method for adaptive throttling of storage service traffic within a client application. The approaches provided herein allow a client or user of a storage service to dynamically and adaptively determine the capability of a storage service to service requests even when the client is not provided with a fixed reserved capacity and when other user may cause the unused capacity to vary. For instance, the approach may include maintaining a computing cluster that accesses a storage service, wherein the remote storage service has limited capacity to service requests, the limited capacity is share among a plurality of clients that access the storage service. Repeatedly determining, at the computing cluster, an available capacity of the storage service based on success or failure of requests, and adaptively throttling requests to the storage service based on at least a then current available capacity.

### BACKGROUND

Historically, companies operated their own computing network with computing services being provided within their computing network. However, with the rise of cloud computing many companies operate in one, or a combination, of approaches including private clouds, public clouds, or hybrid clouds. While such approaches provide greater options for companies these new approaches have also introduced new problems.

Using the private approach, each company generally has to purchase enough computing resources (e.g., processing, storage, and communications hardware such as CPUs, volatile and non-volatile storage, and networking equipment) to handle their peak usage. With the advent of public clouds and hybrid clouds, companies have been able to offload some or even nearly all of their computing requirements to service providers. Such an approach may be beneficial to clients. Such an approach can also make companies more aware of the costs of the technology that they employ because that cost is seen in an ongoing manner instead of as one-time charges for purchase of computing hardware or software—which may or may not be perceived as a benefit.

One area that companies might be able to conserve resources is the utilization of storage. Specifically, a computing cluster (e.g., one that forms a private/public/hybrid cloud) provides readily accessible storage. However, that storage is, relatively speaking, more expensive than dedicated storage services (e.g., object storage facilities such as Amazon's s3 storage which are often used for long term or archival storage). In order to save costs, and to allow users to store their data where they like, dedicated storage services can be accessed by computing clusters and other clients. Unfortunately, one of the reasons that this type of storage is generally cheaper is because of more limited capabilities of the storage service. In particular, each storage service is usually backed by a collection of hardware for a given region which is shared among all users in that region. Moreover, while the storage service may implement per user resource consumption caps, those caps are not normally sufficient to stop the storage service from being overwhelmed by requests from the users of that service. As a result, when the storage service is overwhelmed, requests to store or retrieve data may fail which results in a charge to the customer and wasted effort. Such issues are exacerbated when large or multiple sets of data are to be pushed or pulled to/from the storage service. Furthermore, each customer to the storage service will not generally know the access patterns or even usage of other users of the storage service. As a result, the capability available to any given user can vary dynamically with at least the load placed on the storage service by other users—but the user is not provided a mechanism to know the capability that is actually available to them.

Therefore, there is a need for an improved approach to manage storage service traffic by a client.

### SUMMARY

Embodiments of the present disclosure provide a method, apparatus, and product for adaptive throttling of storage service traffic within a client application.

The approaches disclosed herein generally comprise a method for adaptive throttling of storage service traffic within client applications. The approaches provided herein allow a client or user of a storage service to dynamically and adaptively determine the capability of a storage service to service requests even when the client is not provided with a fixed reserved capacity and when other users may cause the unused capacity to vary. For instance, the approach may include maintaining a computing cluster that accesses a storage service, wherein the remote storage service has limited capacity to service requests, and the limited capacity is shared among a plurality of clients that access the storage service. Adaptively throttling of accesses to the storage service may then comprise repeatedly determining, at the computing cluster, an available capacity of the storage service based on success or failure of requests, and adaptively throttling requests to the storage service based on at least a then current available capacity. In some embodiments, the plurality of clients can together send more requests to the storage service than the storage service can service at any given time. In some embodiments, the storage service is used for LOB or BLOB storage for databases such as SQL databases.

Further details of aspects, objects and advantages of the disclosure are described below in the detailed description, drawings, and claims. Both the foregoing general description and the following detailed description are exemplary and explanatory and are not intended to be limiting as to the scope of the disclosure.

### BRIEF DESCRIPTION OF THE DRAWINGS

The drawings illustrate the design and utility of embodiments of the present disclosure, in which similar elements are referred to by common reference numerals. To better appreciate the advantages and objects of embodiments of the disclosure, reference should be made to the accompanying drawings. However, the drawings depict only certain embodiments of the disclosure, and should not be taken as limiting the scope of the disclosure. The drawings use like reference numerals to identify like elements, and unless otherwise specified, any description for that element may be applicable to each use of that reference numeral were appropriate.

FIG. 1 illustrates an example system in which some embodiments of the disclosure may be implemented.

FIG. 2 is a flowchart for adaptive throttling of storage service traffic within client application according to some embodiments.

FIG. 3 is a more detailed flowchart for determining available capacity of the storage service according to some embodiments.

FIG. 4 is a more detailed flowchart for adaptively throttling requests to a storage service according to some embodiments.

FIG. 5 illustrates an example system in which some embodiments of the disclosure may be implemented.

FIG. 6 illustrates an example complex query node according to some embodiments.

FIGS. 7A-7C illustrate an example flow for processing a command to load customer data according to some embodiments.

FIGS. 8A-8C illustrate an example flow for processing a command to load a cluster object according to some embodiments.

FIGS. 9A-9B illustrate an example flow propagating changed cluster data to a storage service according to some embodiments.

FIGS. 10A-10C illustrate an example flow for processing a recovery command according to some embodiments.

FIG. 11 is a diagram of a computing system suitable for implementing an embodiment of the present disclosure.

FIG. 12 is a block diagram of one or more components of a system environment in which services may be offered as cloud services, in accordance with an embodiment of the present invention.

### DETAILED DESCRIPTION OF THE EMBODIMENTS OF THE DISCLOSURE

Various embodiments are described hereinafter with reference to the figures. It should be noted that the figures are not necessarily drawn to scale. It should also be noted that the figures are only intended to facilitate the description of the embodiment(s) and are not intended as an exhaustive description of the disclosure or as a limitation on the scope of the disclosure. In addition, an illustrated embodiment need not have all the aspects or advantages shown. An aspect or an advantage described in conjunction with a particular embodiment is not necessarily limited to that embodiment and can be practiced in any other embodiments even if not so illustrated.

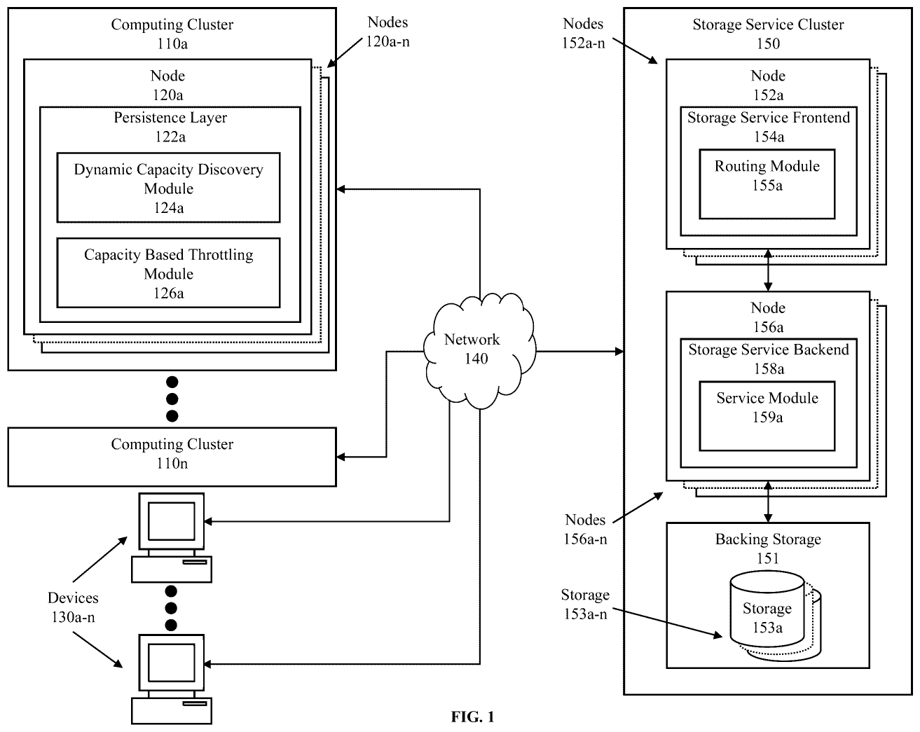

FIG. 1 illustrates an example system in which some embodiments of the disclosure may be implemented. Generally, the approach provided herein is directed towards management of access requests to resources that have limited capacity to handle access requests and where that limited capacity is shared among a plurality of clients in a manner that is not specifically limited to an amount of reserved capacity for each respective client. For instance, a storage service might allow for access by a plurality of different clients where those clients, in aggregate, can overwhelm the capacity of the storage service. As a result, a failure of one request might cascade into multiple failures, as each failure will generally be associated with a retry attempt, and such attempts will likely cause other requests to fail and then subsequent failures will occur, likely multiplying where multiple users attempt to retry failed attempts without knowledge of behavior of other clients that access the storage service. The approach(es) provided herein attempt to remedy this issue by providing a way for a client to determine available capacity at any given time.

In some embodiments, a storage service is provided by a storage service cluster 150. A storage service may provide containers or buckets formed from one or more storage devices at the storage service cluster for clients to store their data at an offsite location (often in the form of a block, object, large object block, or binary large object block, etc.). Such a cluster might be accessible via a network (140) that is accessible locally (when the storage service is in the same installation) or over the internet or a dedicated backhaul connection (when the storage service is in a remote location). As illustrated here, the storage service cluster 150 comprises a first plurality of nodes (152a-n) that include a storage service front end (see e.g., 154a) with a routing module (see e.g., 155a). Additionally, a second plurality of nodes 156a-n is provided that include a storage service backend (see e.g., 158a) and a service module (see e.g., 159a). Finally, the storage service cluster also includes a backing storage (see e.g., 151) where one or more storage devices (see e.g., 153a-n) are provided to hold data (e.g., block, objects, or LOBs) on behalf of clients. At a general level, the storage service is provided as a shared resource accessible to its customers for storage of data on the backing store. However, the underlying hardware resources (e.g., processors, memory, network connections) are for the most part fixed, which is to say that a collection of hardware is configured to provide the service and is not constantly reconfigured to adjust to changing demands on the fly. As a result, the available capacity to service requests is limited. Additionally, due to the number of clients that are serviced by the storage service, such services do not generally assign fixed and reserved capacity to service requests to individual users. Furthermore, even if a reserved capacity is provided to each client, each client may attempt to, and actually exceed that capacity when available. Furthermore, if a cap or max is placed on the amount of capacity that any individual client can consume, the aggregate of each client's cap or max is normally greater than the actual capacity of the system to service requests. Unfortunately for clients, such systems generally charge on a per request basis, regardless of whether the request was successful, and failed requests also waste the resources of the client.

Nodes 152a-n provide a frontend for clients to access the system. The front end generally handles authentication, receives requests, and determines how to route those requests. For instance, each of the nodes (152a-n) may include a collection of application program interfaces (APIs) that allow the user to execute requests as is generally known (see e.g., 154a). These frontends may also include or interface with a routing module (see e.g., 155a) that routes requests to a storage service backend (see e.g., 158a) for storing or retrieving data as needed to service requests. The frontends may use any approach to route communications (see 155a) such as load balancing approaches or data distribution-based approach (e.g., based on a hash, client identifier, container, bucket, or other information) to determine which backend is to receive a request.

Nodes 156a-n receive requests to be serviced from one or more frontends (see e.g., 154a). such requests are then processed using a storage service backend (see e.g., 158a) using a service module (see e.g., 159a) to access backing storage (see 151) which may comprise a collection of non-volatile storage devices (see e.g., 153a-n).

As illustrated herein, the nodes used for the storage service frontend (see 152a-n) and the nodes used for the storage service backend (see 156a-n) are provided separately. However, any combination of nodes and functions or modules could be provided together or separately (e.g., a node might include both a frontend and a backend). Additionally, the routing modules (see e.g., 155a) and service modules (see e.g., 159a) could be provided within or separate from a corresponding frontend and/or backend.

As previously indicated, the storage service (see storage service cluster) may provide services to any number of clients. For instance, individual computing devices (see e.g., devices 130a-n) could be configured to interface with the storage service to provide additional storage—e.g., cold storage, backup storage, redundant storage, and the like. The individual computing devices may comprise any of a computer, tablet, network attached storage, or any other device. In addition, in some embodiments, a collection of devices can also use the storage service. For instance, multiple computing clusters (e.g., private clouds, public clouds, hybrid clouds) could use the storage service for storage purposes e.g., cold storage, backup storage, redundant storage, and the like. As illustrated, any combination of computing clusters 110a-n and devices 130a-n can be configured to interface with and send requests to the storage service for information storage and retrieval over the network (see e.g., 140).

Generally, the computing cluster comprises a collection of nodes (see 110a and 120a-n). In some embodiments, one or more of the nodes may include a persistence layer (see node 120a having persistent layer 122a) for dynamically determining the capacity of the storage service to service requests (see e.g., 124a) and enforcing throttling of requests to the storage service based on that determined capacity (see e.g., 126a). As will be discussed further herein, the capacity may be determined at any level that is relevant such as at the level of the service on the node, at cluster level such as for the service in general, or at a container or bucket (whether at the level of a node or at the cluster level) on the service. In some embodiments, multiple computing clusters include one or more nodes having an instance of the persistence layer as illustrated. In some embodiments, a computing cluster might utilize multiple storage services at any given time, each of which might be associated with a persistence layer or managed by a shared persistence layer as provided herein.

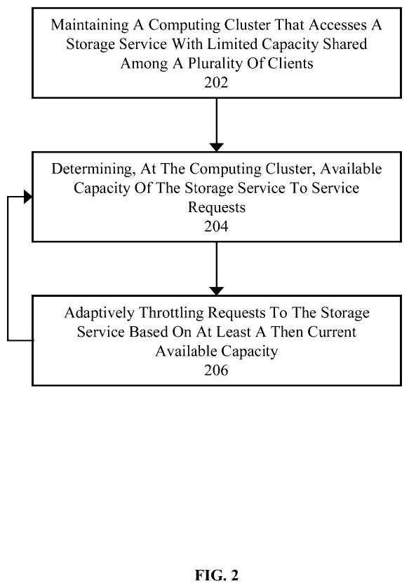

FIG. 2 is a flowchart for adaptive throttling of storage service traffic within client application according to some embodiments.

As an initial matter, a computing cluster is maintained that accesses a storage service with limited capacity that is shared amount a plurality of clients (see 202). For instance, a computing cluster comprising a plurality of nodes may include one or more nodes that access the storage service (see e.g., computing cluster 110a). Additionally, one or more other computing clusters (see e.g., computing clusters 110b-110n) and/or devices (see e.g., devices 130a-n) may also access the same storage service at any given time.

At 204 the computing cluster determines the available capacity of the storage service to service requests. Briefly, the approach provided herein, uses success and failure information for service requests to determine the available capacity at any given time. While this may result in an underestimate of the actual available capacity at any given time (e.g., when the request frequency is low) it will generally detect when the frequency of requests exceeds the available capacity. Given the nature of the storage service, it is not normally an issue when the available capacity is greater than the used capacity as penalties or unnecessary costs are associated with overuse not underuse. In some embodiments, a time window is used to determine the available capacity, where the success and failure of requests is monitored during one time window and then the results from that time window are used to determine the available capacity to be enforced during the next time window. In some embodiments, the results are averaged over time such as via a running average.

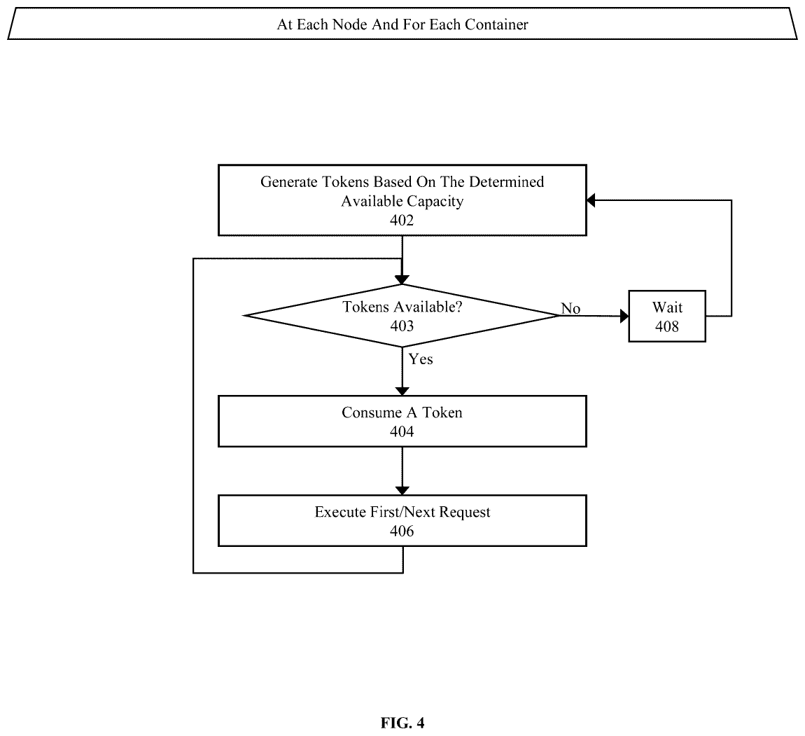

At 206, the frequency or number of requests is throttled based on the then current capacity to service requests as determined at 204. Generally, any known technique can be applied here to throttle requests from the computing cluster to the storage service. For instance, a token-based approach is discussed further herein at least in regard to FIG. 4.

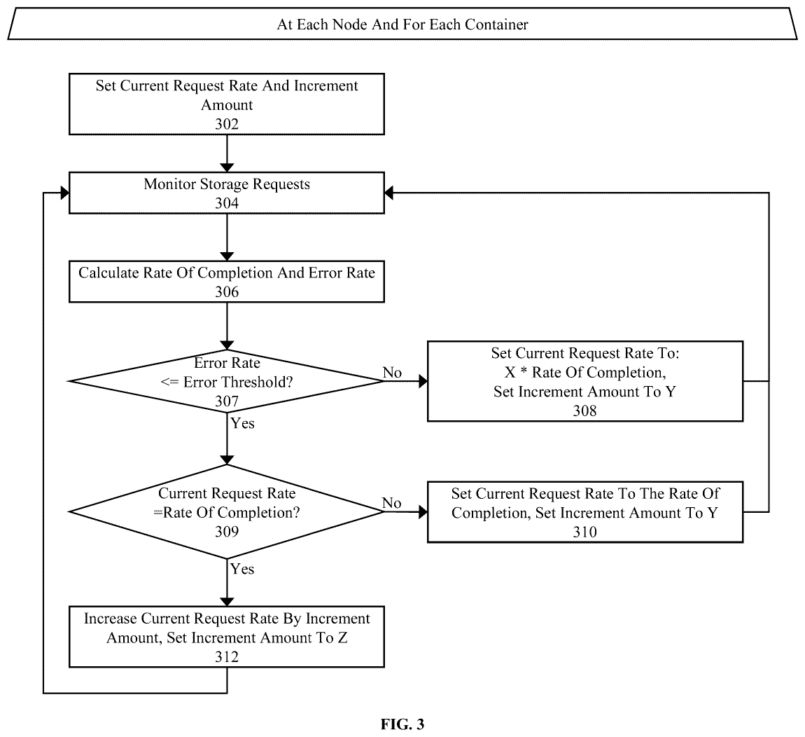

FIG. 3 is a more detailed flowchart for determining available capacity of the storage service according to some embodiments. Generally, the approach provided herein may be used to determine the available capacity of a resource that is dynamically varying. Strictly speaking, such an approach provides an estimate of the actual capacity that is available at any given time regardless of the number of other clients of that resource. In this way, the approaches provided herein can be used by a client of a resource, even when that resource or resource provider does not specify the resources capabilities. The approach provided herein may be applied at multiple levels, such as at the service level, the region level (e.g., where the service has different regional storage centers), at the level of each node or each container whether at the cluster level or the node level (buckets and containers are treated the same herein). For the purpose of the discussion of FIG. 3 the approach is primarily described in regard to operation at the level of each node and container where each process is performed separately for each unique combination of a node and a container.

The process generally starts at 302 where a current request rate is set to an initial request rate and an increment amount is set to an incremental request rate. The initial request rate may be set based on any factor such as a fixed value (e.g., 1, 10, 100, 1000 etc.), based on a last known value (e.g., a value determined before a shutdown or failure of the connection or computing cluster), or based on a minimum value (e.g., a reserved capacity value provided by the storage service provider). For the sake of the discussion of this figure we will presume that the initial value is set to 1. Additionally, an increment amount is set. The increment amount generally represents the initial granularity with which the request rate will be increased when there is more capacity available. For the sake of the discussion of this figure we will presume that the initial value is set to 1.

At 304, storage requests (e.g., object storage requests) are monitored. In some embodiments, each node monitors the requests that it sends for success and failure and determines the actual capacity based solely on the success and failure of requests that it send. For instance, for each container a tally is generated of successes and failures of requests. Subsequently, each node then determines the actual capacity (the estimate of the actual capacity available to that particular node) for each container that the node accesses based on that corresponding success and failure information. In some embodiments, each node reports to a shared storage area (e.g., memory, database, cache) that is accessible to multiple nodes to incorporate their individual success and failure information into that shared storage area for determining, at the level of the cluster, the available capacity of the storage service for each corresponding container—e.g., a central location processes the information for the container or an assigned owner of each container processes the information of each node. Such information can have any granularity as appropriate such as per provider, region container/bucket. Regardless, once the storage request success and failure information is collected it can be processes. Additionally, the success and failure information is captured over time. For instance, a running average or a rate over a given time period is determined.

At 306, the process calculates the rate of completion and the error rate. The rate of completion might comprise the success rate (e.g., the number of requests that were completed successfully). Similarly, the error rate might comprise a ratio of the number of retry attempts required per request over the total number of requests in a time period (e.g., if 10 requests were made, 7 completed without a retry, 2 completed with 1 retry each, and one completed with 3 retries, then the error rate might comprise (1+1+3)/10= 5/10=½=0.5). In some embodiments the error rate is equal to the number of retries. If no failures occurred the error rate is zero.

At 307 it is determined whether the error rate is less than or equal to a threshold. If the error rate does not exceed the threshold, the process continues to 309 where it is determined whether the current request rate is equal to the rate of completion. Strictly speaking, the rate of completion should not exceed the current request rate. However, if that where to happen it could be treated in the same way as if the current request rate and the rate of completion are the same. If the current request rate is less than or equal to the rate of completion as determined at 309 the process continues to 312 where the current request rate is increased by the increment amount and the increment amount is set to Z. For example, an initial increment amount might be 1, and at 312 the increment amount is set to two times the current increment amount. This would essentially cause exponential growth when the answer of 307 and 309 continues to be yes—e.g., the increment amount would be equal to 1 then 2, then 4, then 8, then 16 etc. similarly the current request rate would be equal to 1, then 2, then 4, then 8, then 16 etc.

However, in the event that the answer at 307 is no because the error rate exceeds the error threshold, then the process will proceed to 308 where the current request rate will be set to a fractional value (X) times the rate of completion (e.g., 0.5*the rate of completion) and the incremental amount is reset to a new value Y (e.g., back to 1). After which the process will return to 304 to monitor success and failure rates for another time period.

Similarly, in the event that the answer at 309 is no, because the current request rate is not equal to or greater than the rate of completion, the process proceeds to 310 where the current request rate is set to the rate of completion and the increment amount is set to Y (e.g., back to 1). After which the process will return to 304 to monitor success and failure rates for another time period.

In this way, the process balances the rate of requests to the available capacity at a given time subject to a tolerance for errors. Furthermore, exponential growth of the requests rates may be used to quickly raise the request rate close to the actual capacity for handling requests by the storage service.

FIG. 4 is a more detailed flowchart for adaptively throttling requests to a storage service according to some embodiments. As provided here, the adaptive throttling is completed using a token-based approach. Generally, the token-based approach may be implemented by each node and for each container to maintain a fine level of granularity. However, in some embodiments, tokens could be shared across the cluster for a storage service or a container/bucket.

The process generally starts at 402 where tokens are generated based on the determined available capacity which is set to the current request rate discussed in regard to FIG. 3. In some embodiments, each request requires and consumes one token. If there are available tokens (see 403) the process can proceed to 404 where a token is consumed (e.g., deleted or marked as used) and to 406 where the first or next request is executed that corresponds to that token. For example, tokens may be specific to a container on the storage service. Thus, when a token is consumed, the first or next request for the corresponding container is executed. However, if at 403 it is determined that no tokens remain, the process will wait (see e.g., 408) until more tokens are available (e.g., until the start of a subsequent time period). In some embodiments, tokens are generated all at once for a given time period (e.g., the number of tokens is adjusted to match the available capacity). In some embodiments, token generation is managed by creating tokens at an interval that would create the corresponding number of tokens to match the capacity (e.g., using a leaky bucket type approach).

In some embodiments, the throttling is used to send batched requests. For instance, the persistence layer executes a batch of requests—e.g., HTTP requests using curl library where the batch may comprise a specified number of requests (e.g., 16). Furthermore, such requests might be sent in parallel using multiple connections to the storage service.

In some embodiments, a failed request is identified by a storage service response—e.g., and HTTP code 429/503. In such a case, the failed requests within a batch may be retried using an exponential backoff algorithm until all requests in the batch complete successfully or the process runs out of retry attempts.

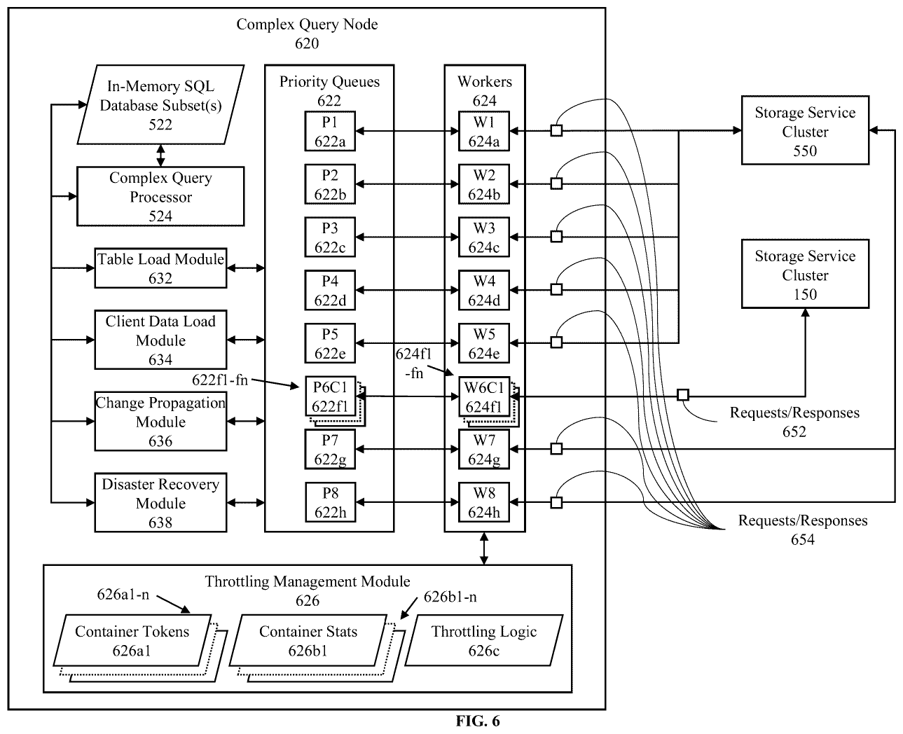

In some embodiments, nodes in a cluster (e.g., computing cluster 110a) try to access the same overloaded storage service or container (e.g., storage bucket) and as a result the retry cycles in the threads synchronize. Due to this synchronization, a phenomenon called thundering herd happens where all the threads in all the nodes attempt to retry simultaneously which momentarily increases the load on the same service or container and, as a result, a lot of those requests will likely fail. In order to solve this issue, in some embodiments, jitter is introduced to a retry interval. Essentially, each process (e.g., workers discussed below in regard to FIG. 6) computes a retry interval based on an exponential backoff and then adds a random jitter to that interval (e.g., 50%). This prevents the retry attempt processes from synchronizing.

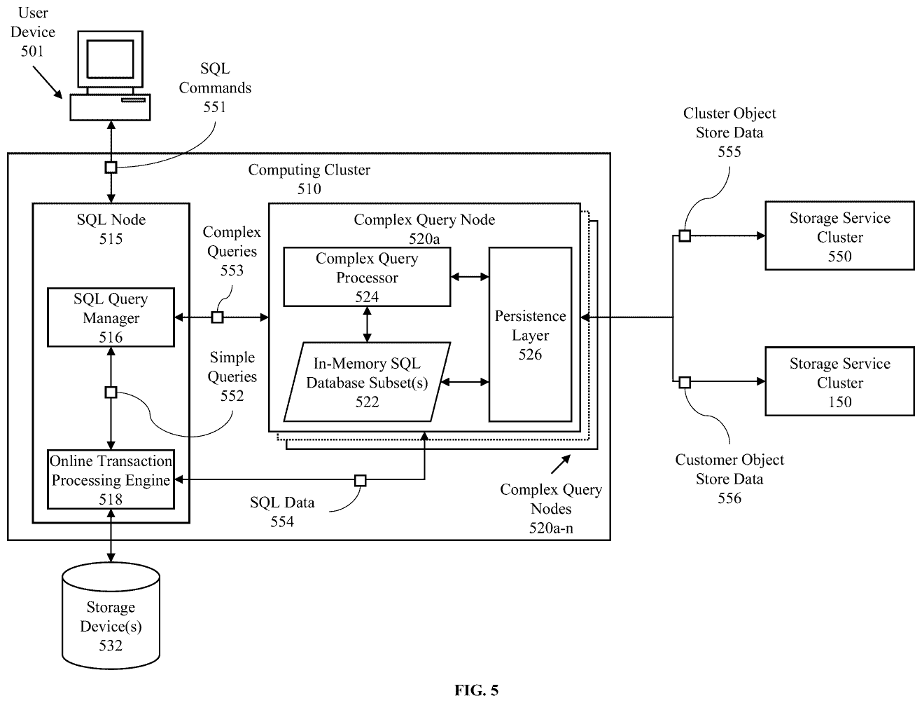

FIG. 5 illustrates an example system in which some embodiments of the disclosure may be implemented. For instance, a cluster such as the clusters discussed above in regard to items 110a-n) may be used to provide an SQL service that utilizes the approaches provided herein.

The process may be leveraged to execute at least a command (see e.g., SQL commands 551) received from a user device. For instance, such a command might comprise a simple SQL query (e.g., a query that would return a single value or row of a table), a complex SQL query (e.g., a query that requires multiple processing steps to generate an output) to be executed on SQL data maintained in memory, an instruction to load data from a user container into a SQL database either on non-volatile storage or in memory (e.g., volatile storage such as RAM) that is forwarded to a storage service, or an instruction to load data from a cluster container into a SQL database either on non-volatile storage or in memory (e.g., volatile storage such as RAM) that is forwarded to a storage service.

The computing device 501 interacts with an SQL node to allow users to interact with the SQL database. Furthermore, the computing devices might be controlled by a user, another service, an administrator, or comprise any other computing device that allows data access or management of a SQL database or an element therein. The computing device 501 comprises any type of computing device that may be used to operate or interface with the SQL database instance, whether directly or indirectly. Examples of such user computing devices 501 include workstations, personal computers, laptop computers, or remote computing terminals. User computing devices 501 may also comprise any type of portable tablet device, including for example, tablet computers, and portable readers. User computing device 501 may also include mobile telephone devices relating to any mobile device that can suitably access any computing systems on the Internet such as smartphones and programmable mobile handsets. It is noted that the disclosure is not limited in its application to just these types of devices. The embodiments of the disclosure are applicable to any computing device that works in conjunction with access to digital information stored on, as an example, the Internet. One of ordinary skill in the art would appreciate that embodiments of this present disclosure may be implemented on the Internet, on a closed network, on a hybrid open and closed network, or on a cloud network.

In some embodiments, the SQL commands are routed to an SQL node (see 515) that executes a software stack for implementing an SQL database and which processes simple SQL queries, and directs and forwards complex SQL queries to other nodes for processing against at least a portion of the SQL database in memory. For instance, simple SQL queries (see 552) are executed against an SQL database using an online transaction processing engine (see 518) by at least accessing one or more storage devices (see 532) that maintain the data of the SQL database. Simple queries generally may comprise smaller lookup operations (e.g., operations that are to return singular values, rows, or columns, or operate on singular tables). Complex queries may comprise queries that return multiple values, require multiple calculations or operations or operate on multiple tables to determine an output. In contrast to the simple SQL queries which are serviced directly by the SQL node, complex SQL queries (see 553) are forwarded to one or more nodes for execution against an in-memory portion of an SQL database or subsets thereof.

As provided herein, there may be multiple nodes that service complex queries alone or in combination (see e.g., 520a-n). As a general matter, when a complex query is received, a receiving node may analyze the query to determine whether the necessary information is maintained in memory (see 522). If the necessary portion is not maintained in memory, but is maintained in the SQL database (see 532) that information may be processed and loaded into memory (see 554). Likewise, if the necessary information is not in memory and is not in the SQL database that information may be retrieve from an identified location (e.g., from a container on a storage service). Retrieval from the storage service may be implemented using a persistence layer (see 526) which will be discussed further in FIG. 6. In some embodiments, if the necessary portion is not maintained in memory, it may be streamed from a storage service (see e.g., 150 and 550) or it may be processed using the online transaction processing engine (see 518). In some embodiments, a receipt of a complex query that requires data that is not in one or a combination of complex query nodes is used to trigger the reproduction of the necessary data in one or a combination of complex query nodes.

In some embodiments, the persistence layer supports any number of storage services and containers. For instance, a first storage service cluster 550 might be configured to provide backing storage for the computing cluster 510 and maintain cluster object store data (see 555) that can be sent to and retrieved from the storage service for disaster recovery purposes. Additionally, the same or a separate storage service (see e.g., 150) could be used by clients or customers to store data (e.g., database entries—whether as a backing store, cold storage, or any other purpose) (see also 556). In some embodiments, the storage service is used to store large objects for the SQL database (e.g., LOBS or BLOBS—which are large objects which may comprise structured or unstructured data). The storage services may store data any in any number of formats (e.g., blocks, objects, LOBs, BLOBs) and may present that data in any form to a user using a corresponding frontend or backend process.

In some embodiments, the complex query node(s) and the online transaction processing engine communicate to exchange changes to the SQL database (e.g., changes at a complex query node are sent to the online transaction processing engine for reproduction in an on disk representation (see 532) and changes at the online transaction processing engine are sent to the complex query node(s) for reproduction in an in memory representation (see 522)). In some embodiments, changes to the SQL database are only made by the online transaction processing engine and are subsequently propagated to the complex query node(s) for reproduction. In some embodiments, a subset of data is only maintained in a complex query node(s), such as customer data retrieved from a storage service. In some embodiments, changes can be made to customer data and reproduced at a storage service—e.g., at a storage service from which that data was received or from a separate storage service which may comprise a storage service used for the cluster data.

FIG. 6 illustrates an example complex query node according to some embodiments. Specifically, FIG. 6 illustrates more detailed embodiments of the complex query nodes illustrated in FIG. 5.

The complex query node 620 includes the complex query processor 524 and the in-memory database subset(s) 522 discussed above in regard to FIG. 5. In addition, the complex query node includes multiple other elements to interact with at least storage services, including a table load module 632, a client data load module 634, a change propagation module 636, a disaster recovery module 638, and a throttling management module 626.

As a general matter, the table load module 632 persists table data from a storage service into the in-memory SQL database subset(s) 522. Normally, such data was previously processed for in-memory storage and for fast access therein. However, such data may have at one time been lost from a particular node (e.g., due to node or component failure) or removed (e.g., to make room for other data, for timeout, and for other cleanup operations). Additionally, the table load module serves the needs of the cluster thus can be used to load objects (e.g., from a corresponding storage service) for cluster management purposes as opposed to client purposes. Similarly, a client data load module 634 is provided that can load data from a client associated storage service. However, in contrast to the table load module 632, the client module retrieves data that was stored by the client and is not normally maintained in a format that is optimized for in-memory storage. As such the client data load module may convert or cause the conversion of retrieved data to a format that is optimized for in-memory storage and analysis.

The change propagation module 636 is provided for disaster recovery purposes. Specifically, the change propagation module can collect changes to the in-memory representation for storage at a storage service should recovery be necessary in the future. The related disaster recovery module 638 can be used to retrieve some or all of the data that was previously captured (e.g., to return the in-memory SQL database subset(s) to a prior state). Additional modules could also be provided for other purposes such as a garbage collection or cleanup module or a module to propagate changes between the on-disk SQL database and the in-memory SQL database subset(s).

As a general matter, as each request is received (e.g., from a client) the complex query processor 524 may determine whether one of the indicated modules are necessary to execute the query and forward the query or instructions thereof to the appropriate module for generation of jobs to be executed by workers of the complex query node. For example, each job may be placed into a priority queue (see 622) that corresponds to the job, where P1 (see 622a) might be the highest priority queue, while P8 (622h) is the lowest priority queue. In some embodiments, one or more rules are provided for determining the priority of each job, after which job is placed into the corresponding queue (see e.g., any of 622a-h including 622f1-622fn). There could be any number of queues though only 8 are illustrated here. For instance, in some embodiments, disaster recovery operations have the highest priority, followed by change propagation operations, then table load operations, a then client data load operations, after which garbage collection and cleanup operations follow.

After jobs are placed into their corresponding priority queues, a corresponding worker may attempt to execute those jobs (see e.g., workers 624, 624a-h including 624f1-624fn). In some embodiments, multiple workers are provided where each queue has a corresponding worker that is called after a worker for higher priority jobs completes all scheduled tasks or runs out of tokens. Specifically, each worker will check the corresponding priority queue (e.g., W1 check P1) to determine if there are any available jobs. If there are no available jobs, the worker will call the next worker (e.g., W1 calls W2). However, if there are any pending jobs the worker will check the corresponding container tokens to determine if there are any available tokens for that job. Specifically, the worker will determine which container the job requires access to, and then access the corresponding collection of tokens to determine whether the corresponding collection of tokens has any unused tokens. If there any unused tokens the worker marks the token as used and executes the job before repeating the process until either all tokens for the corresponding container have been exhausted or all jobs have been exhausted. This process is then repeated by each worker. In some embodiments, each worker executes includes multiple connects to a storage service to for execution of multiple requests in parallel.

In some embodiments, priority queues are divided based on the corresponding container or service. For instance, each priority queue might correspond to one container. In some embodiments, each queue corresponds to a function which may corresponding to one or more containers. In some embodiments, separate priority queues and workers are provided for customer containers where one container corresponds to one queue and one worker.

As provided herein, each worker (see workers 624) may send requests and receive responses (see e.g., requests/responses 652 and requests/responses 654) to/from a storage service (see e.g., storage service cluster 550 and 150) as described herein.

The operation of the priority queues 622 and the workers 624 are generally throttled using the throttling management module 626 which includes container tokens 626a1-626an, container statistics 626b1-626bn, and throttling logic 626c. As provided herein, the throttling logic may comprise a representation of logic for determining the available capacity of the storage service to service requests (See e.g., 204 or FIG. 3) which may be represented by a number of tokens for each container (see e.g., 206 or FIG. 4) which is represented in at least 626a1-n. Additionally, the number of tokens may be determined based on the container statistics with are maintained on at least a per container basis in container stats 626b1-626bn.

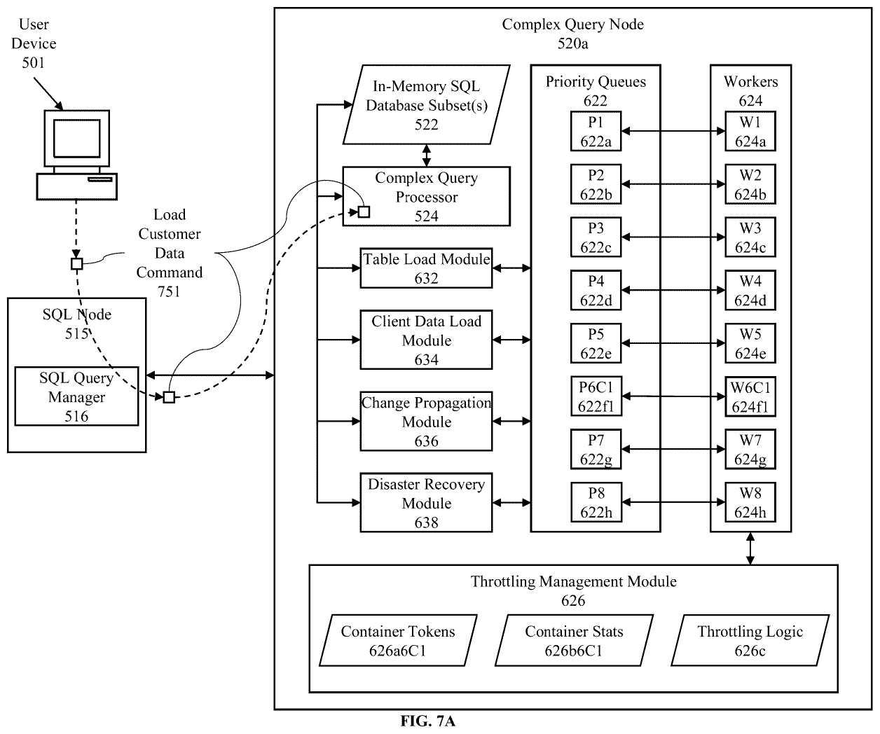

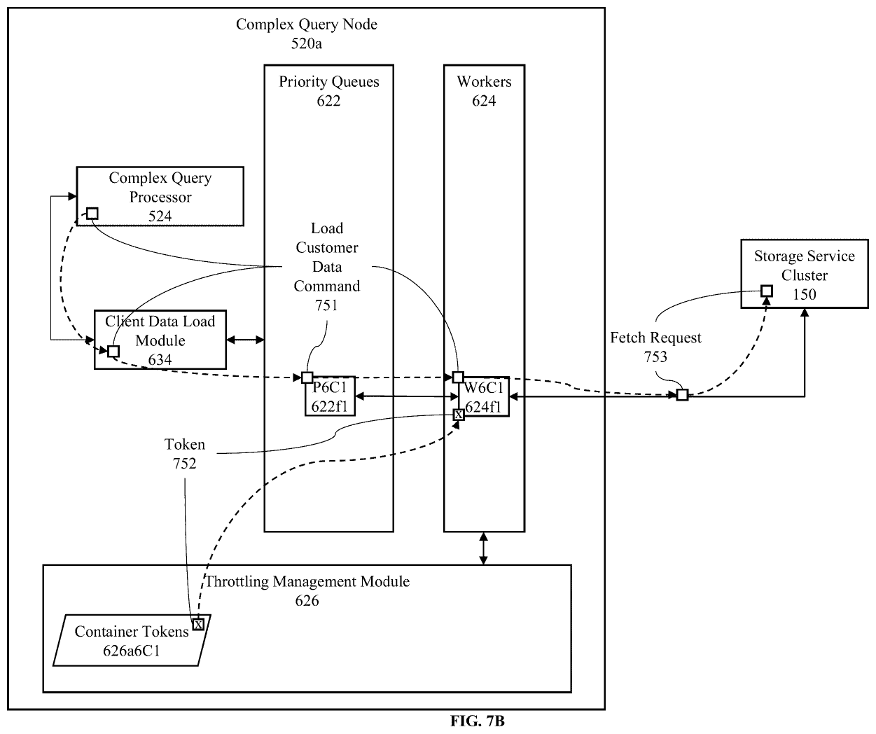

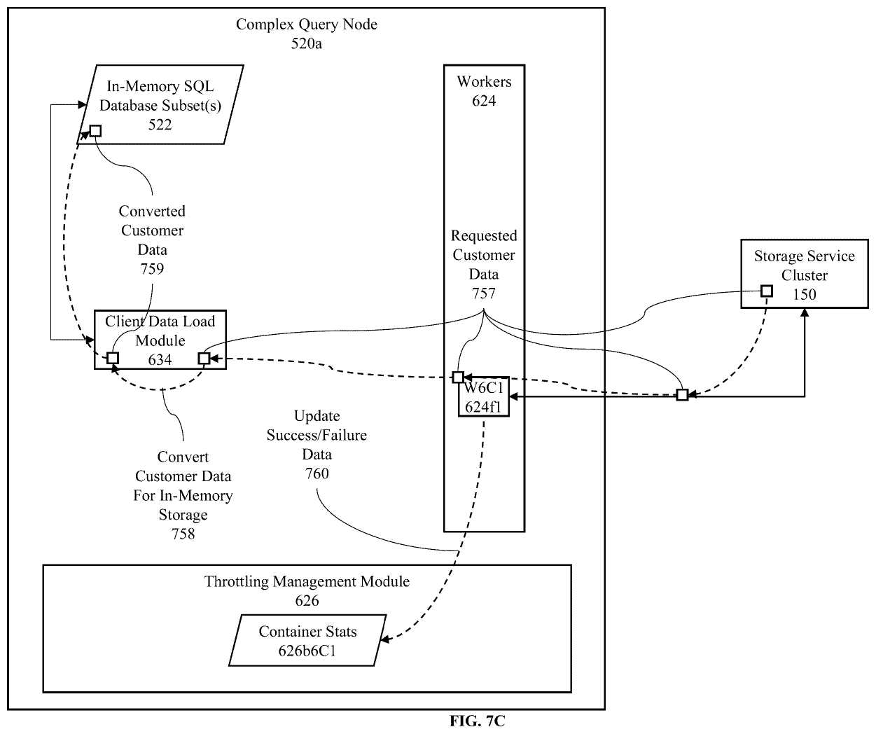

FIGS. 7A-7C illustrate an example flow for processing a command to load customer data according to some embodiments. As provided herein this example builds on that of FIG. 6 and thus the description of elements identified by the same reference number are applicable to the present figure. Additionally, some elements not necessary to the specific illustration have been omitted to increase clarity of the illustrated flow.

FIG. 7A illustrates a first portion of an example flow for processing a command to load customer data according to some embodiments.

The process generally starts when a load customer data command (e.g., a command to load customer data from a storage service) is received from a client. Such a command might be received by an SQL node (e.g., 515) and processed at least by an SQL query manager 516 by routing the command (see 751) to a complex query processor 524. In some embodiments, the SQL Query Manager 516 routes the communication directly to the relevant module at a complex query node (e.g., to the client data load module 634).

FIG. 7B illustrates a second portion of an example flow for processing a command to load customer data according to some embodiments.

In the second portion, the load customer data command (see 751) is routed to the corresponding module (see 634) by the complex query process (524). The client data load module 634 in turn queues the command into the corresponding priority queue—e.g., P6C1 which is identified as 622f1. Once queued the command will sit on the queue until the corresponding worker can execute that job. In particular, a worker will check to determine whether there is an available token in a collection of tokens for the container that the client has requested that data be loaded from to processed the job (see e.g., container tokens 626a6C1). If there is an available token (see 752) the worker will mark the token as used and associate it with the load customer data command before sending a fetch request (see 753) to the storage service having the container (see e.g., 150)

FIG. 7C illustrates a third portion of an example flow for processing a command to load customer data according to some embodiments.

Specifically, the requested customer data is received from the storage service (see 757

and 150) at the worker (see 624f1) which forwards that data back to the client data load module 634 and updates success/failure data for the corresponding container (see 760 and 626b6C1). In some embodiments, the client data load module 634 converts the customer data for in-memory storage (see 758)—e.g., into a format that is optimized for in memory processing. In some embodiments a separate process may be provided for conversion of customer data for in-memory storage. Regardless, after conversion the converted customer data is stored in an in-memory SQL database subset(s) 522 (see e.g., 759). In some embodiments, the customer data is only maintained in the in-memory SQL database subset(s) 522 but not in the storage devices 532. In some embodiments, the customer data is reproduced on the storage service cluster for the system after being processed and added to the in-memory SQL database subset(s) 522.

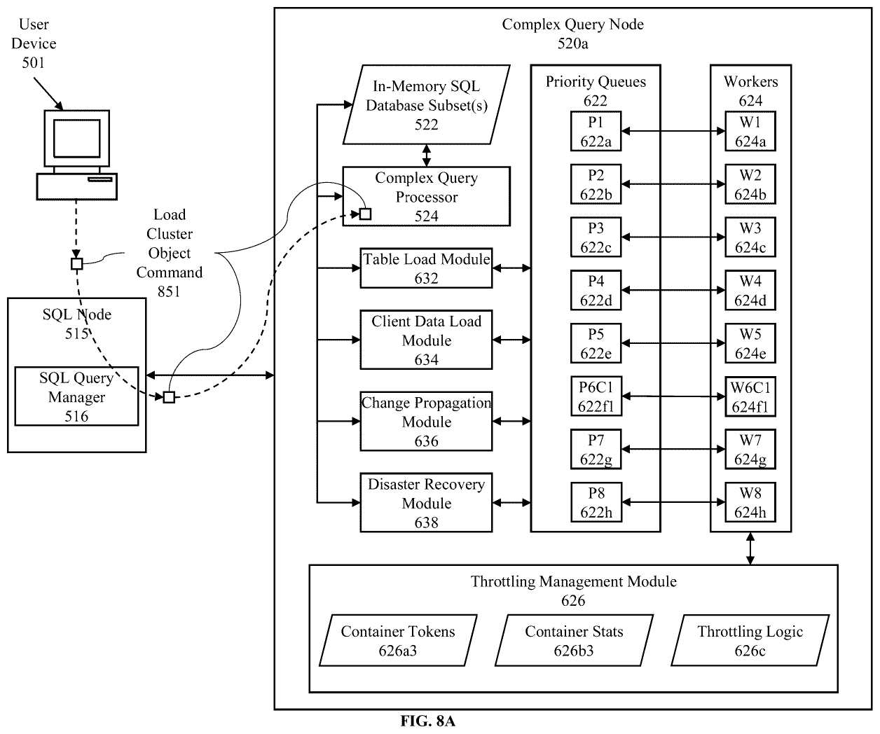

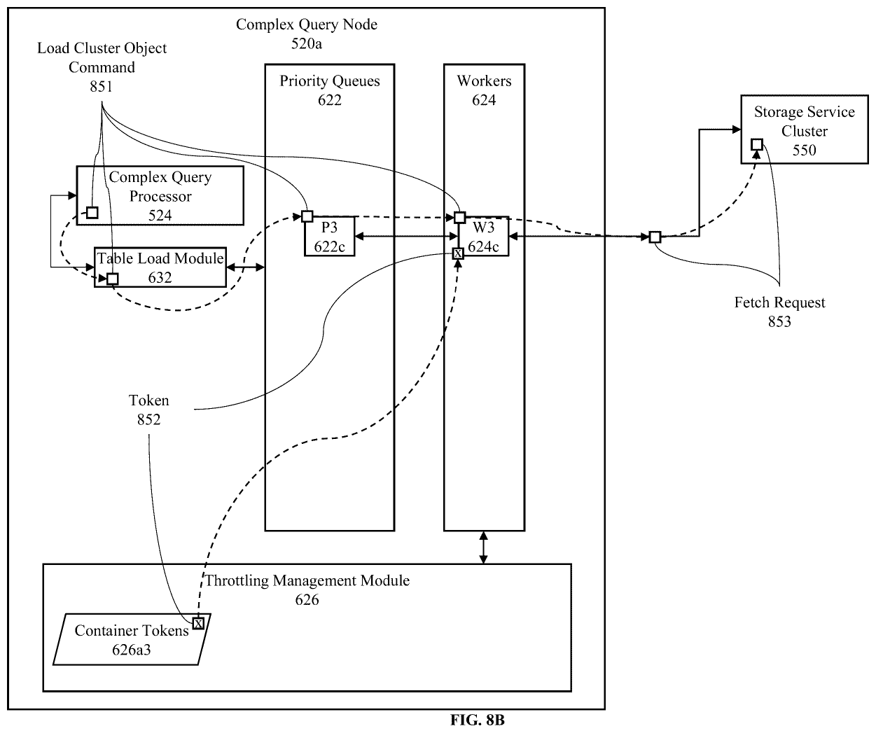

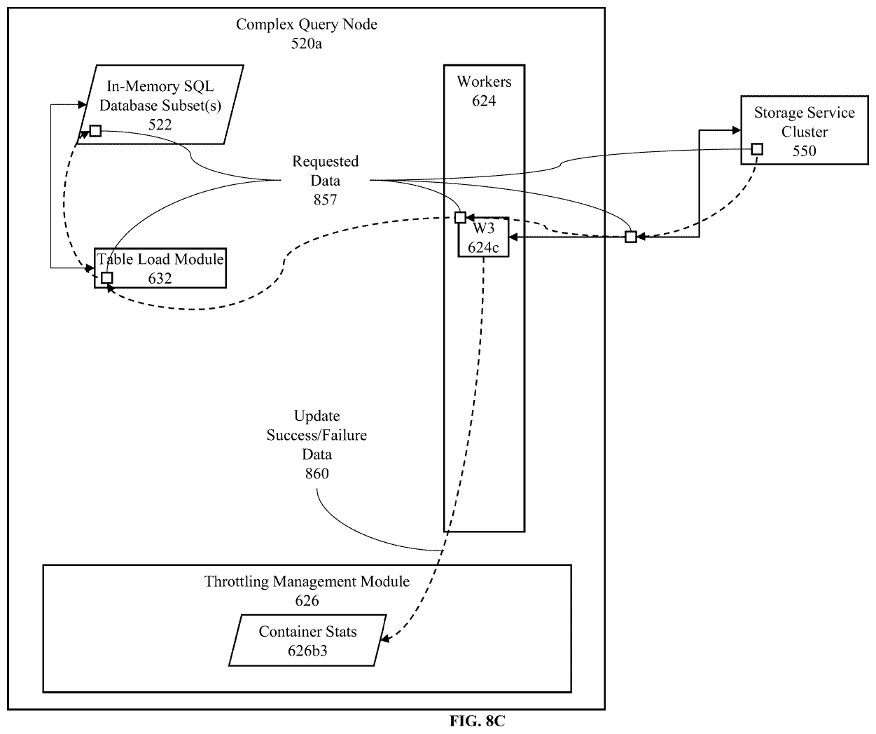

FIGS. 8A-8C illustrate an example flow for processing a command to load a cluster object according to some embodiments. As provided herein this example builds on that of FIG. 6 and thus the description of elements identified by the same reference number are applicable to the present figure. Additionally, some elements not necessary to the specific illustration have been omitted to increase clarity of the illustrated flow.

FIG. 8A illustrates a first portion of an example flow for processing a command to load a cluster object according to some embodiments. The process for loading a cluster object is similar to the process to a load customer data but operates using at least a different queue, worker, and container.

The process generally starts when a load cluster object command (e.g., a command to load a cluster object from a storage service) is received from an administrator. Such a command might be received by an SQL node (e.g., 515) and processed at least by an SQL query manager 516 by routing the command (see 851) to a complex query processor 524. In some embodiments, the SQL Query Manager 516 routes the communication directly to the relevant module at a complex query node (e.g., to the table load module 632). In some embodiments, the load cluster object command is generated internally by an automated process for managing which portions of an SQL database are maintained in-memory by the complex query node(s).

FIG. 8B illustrates a second portion of an example flow for processing a command to load a cluster object according to some embodiments.

In the second portion, the load cluster object command (see 851) is routed to the corresponding module (see 632) by the complex query processor (524). The table load module 632 in turn queues the command into the corresponding priority queue—e.g., P3 which is identified as 622c. Once queued the command will sit on the queue until the corresponding worker can execute that job. In particular, a worker will check to determine whether there is an available token in a collection of tokens for the container that the administrator has requested that data be loaded from to process the job (see e.g., container tokens 626a3). If there is an available token (see 852) the worker (624c) will mark the token as used and associate it with the load cluster object command before sending a fetch request (see 853) to the storage service having the container (see e.g., 550). As provided herein, the storage service used by the cluster is different from the storage service used by the customer. However, in some embodiments, a cluster and a customer may use the same storage service.

FIG. 8C illustrates a third portion of an example flow for processing a command to load a cluster object according to some embodiments.

Specifically, the requested cluster data is received from the storage service (see 857 and 550) at the worker (see 624c) which forwards that data back to the table load module 632 and updates success/failure data for the corresponding container (see 760 and 626b3). Additionally, the requested data (see 857) is stored in an in-memory SQL database subset(s) 522 (see e.g., 759).

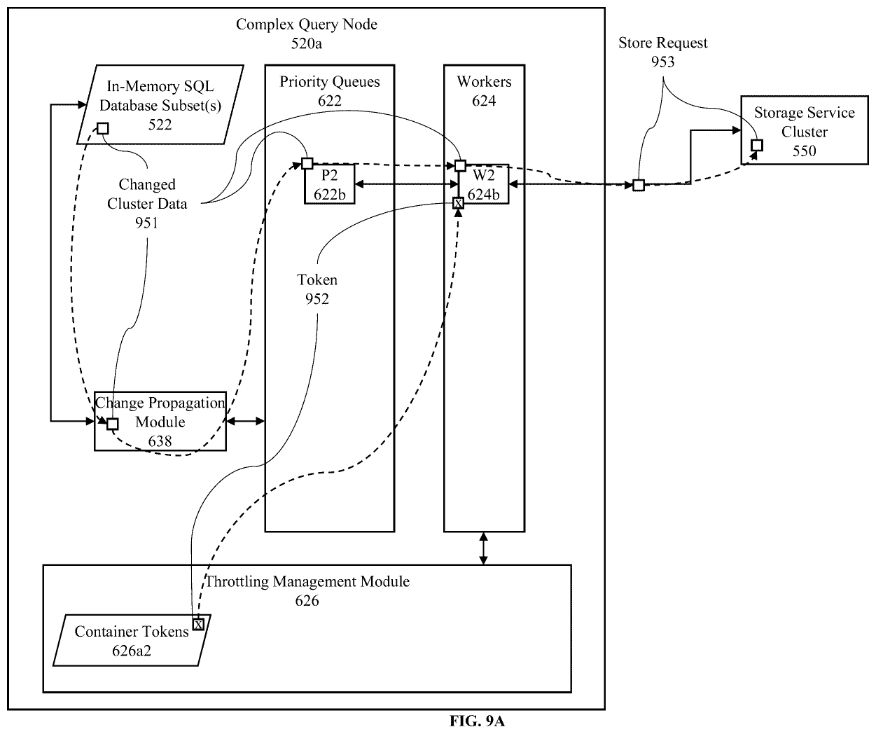

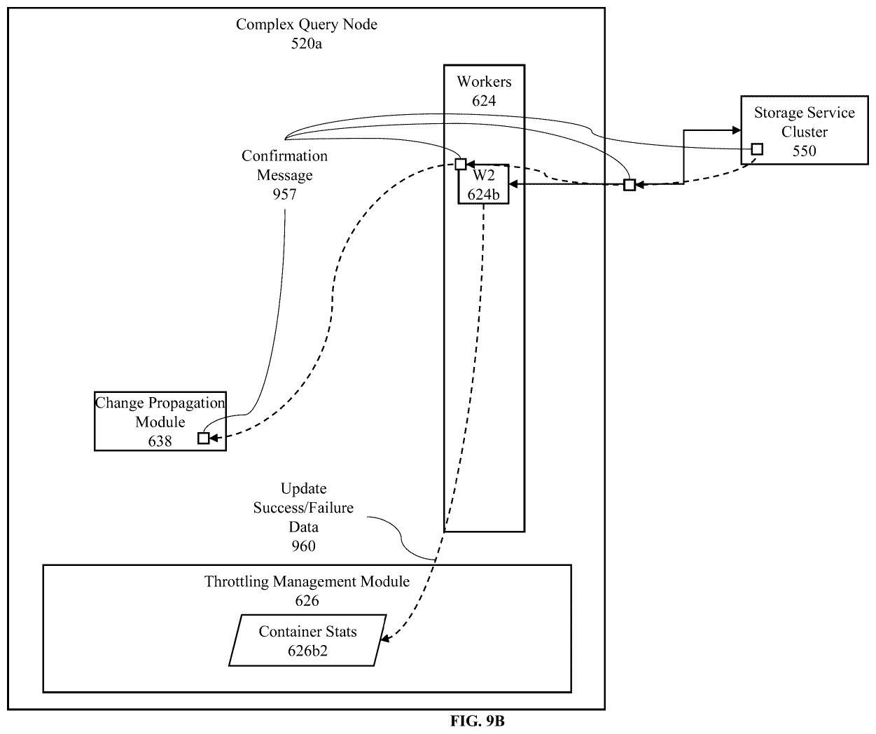

FIGS. 9A-9B illustrate an example flow for propagating changed cluster data to a storage service according to some embodiments. As provided herein this example builds on that of FIG. 6 and thus the description of elements identified by the same reference number are applicable to the present figure. Additionally, some elements not necessary to the specific illustration have been omitted to increase clarity of the illustrated flow.

FIG. 9A illustrates a first portion of an example flow for propagating changed cluster data to a storage service according to some embodiments. In contrast to the flows illustrated in FIGS. 7A-C and 8A-C, the flow in FIGS. 9A-9B is normally started by the change propagation module.

The process generally starts in a periodic manner, in response to a change to the in-memory SQL database subset(s) 522, or a combination thereof. In particular, the change propagation module (638) queues a job into the corresponding priority queue (e.g., P2 which is identified as 622b) to transfer the change or a collection thereof onto the storage service in a given container (see changed cluster data 951).

Once queued the job will sit on the queue until the corresponding worker can execute that job. In particular, a worker will check to determine whether there is an available token in a collection of tokens for the container that the process has requested that data be stored to process the job (see e.g., container tokens 626a2). If there is an available token (see 952) the worker (624c) will mark the token as used and associate it with the changed cluster data before sending a store (put) request (see 953) to the storage service having the container (see e.g., 550).

FIG. 9B illustrates a second portion of an example flow for propagating changed cluster data to a storage service according to some embodiments.

Specifically, upon a successful execution of a store command, a confirmation message is received that indicates that the provided changed cluster data was stored by the storage service (see 957 and 550) at the worker (see 624b) which forwards that confirmation back to the change propagation module 638 and updates success/failure data for the corresponding container (see 960 and 626b2).

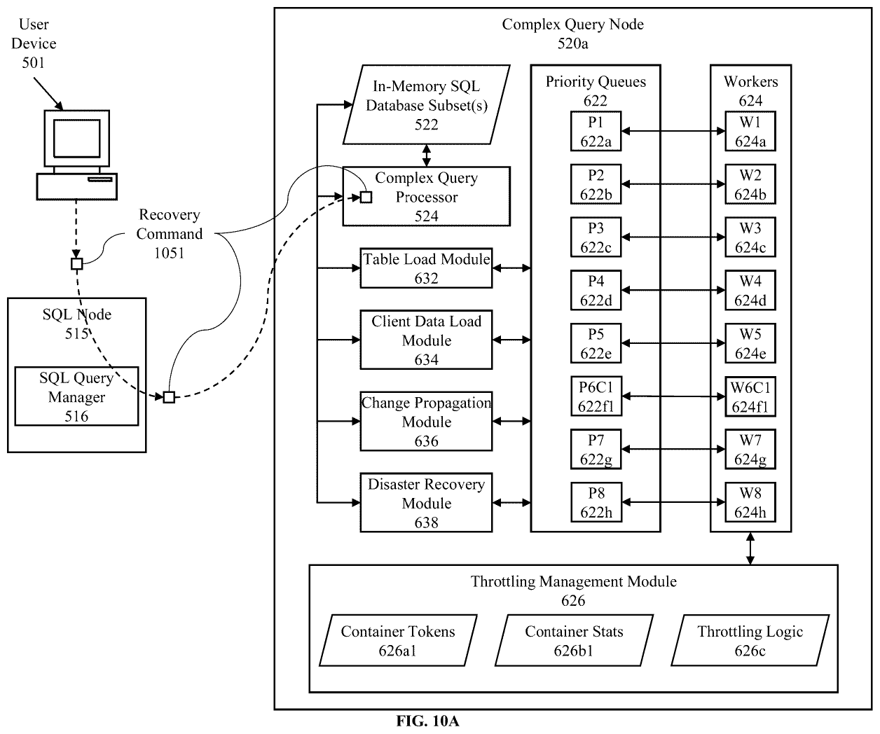

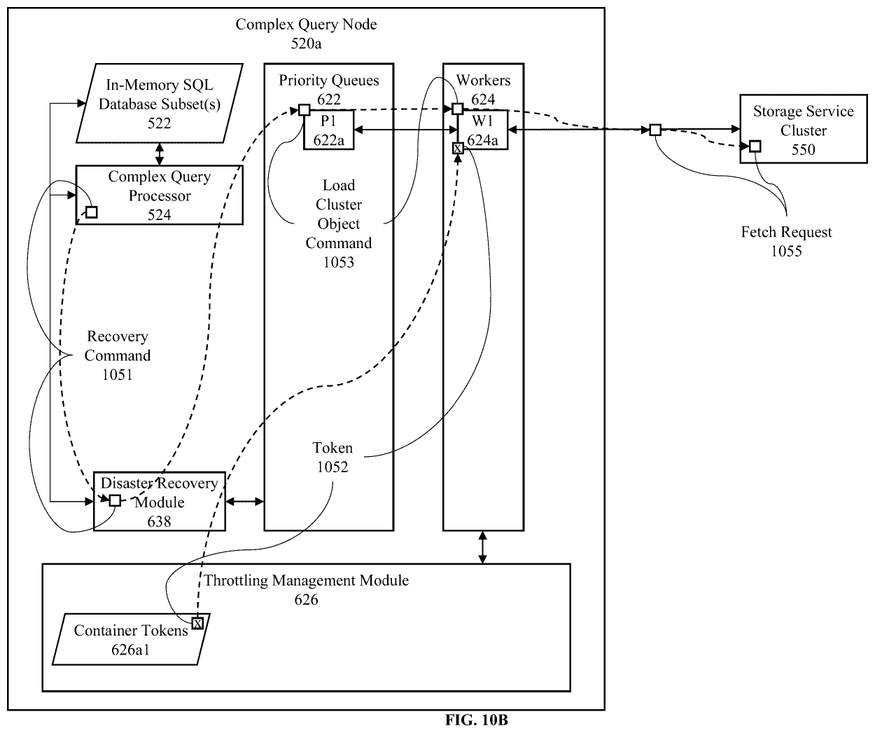

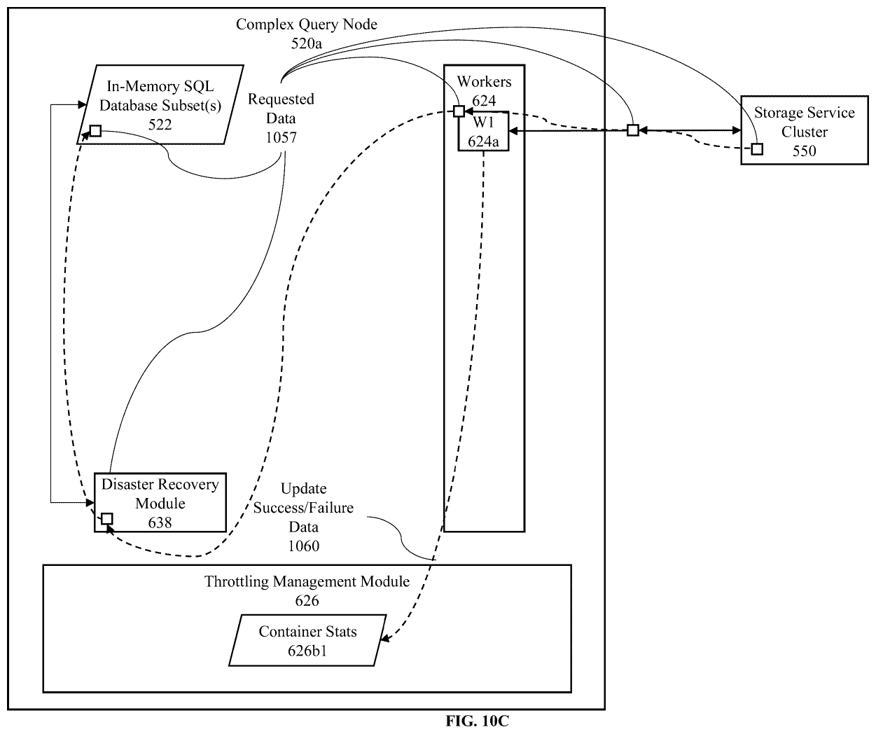

FIGS. 10A-10C illustrate an example flow for processing a recovery command according to some embodiments. As provided herein this example builds on that of FIG. 6 and thus the description of elements identified by the same reference number are applicable to the present figure. Additionally, some elements not necessary to the specific illustration have been omitted to increase clarity of the illustrated flow.

FIG. 10A illustrates a first portion of an example flow for processing a recovery command according to some embodiments.

The process generally starts when a recovery command (e.g., a command to recover the in-memory database subset(s) to a previously captured state) is received from an administrator. Such a command might be received by an SQL node (e.g., 515) and processed at least by an SQL query manager 516 by routing the command (see 1051) to a complex query processor 524. In some embodiments, the SQL Query Manager 516 routes the communication directly to the relevant module at a complex query node (e.g., to the disaster recovery module 638).

FIG. 10B illustrates a second portion of an example flow for processing a recovery command according to some embodiments.

In the second portion, recovery command (see 1051) is routed to the corresponding module (see 638) by the complex query process (524). The recovery module 638 queues one or more jobs (load cluster object commands 1053) into the corresponding priority queue—e.g., P1 which is identified as 622a. Once a job is queued it will sit on the queue until the corresponding worker (e.g., W1 identified as 624a) can execute that job. In particular, a worker will check to determine whether there is an available token in a collection of tokens for the container that the recovery process has instructed that data be loaded from to recover the in-memory SQL database segments (see e.g., container tokens 626a1). If there is an available token (see 1052) the worker will mark the token as used and associate it with the corresponding job before sending a fetch request (see 1055) to the storage service having the container (see e.g., 550)

FIG. 10C illustrates a third portion of an example flow for processing a recovery command according to some embodiments.

Specifically, the requested data is received from the storage service (see 1057 and 550) at the worker (see 624a) which forwards that data back to the disaster recovery module 638 and updates success/failure data for the corresponding container (see 1060 and 626b1). The requested data is then stored in an in-memory SQL database subset(s) 522 (see e.g., 1057).

### System Architecture

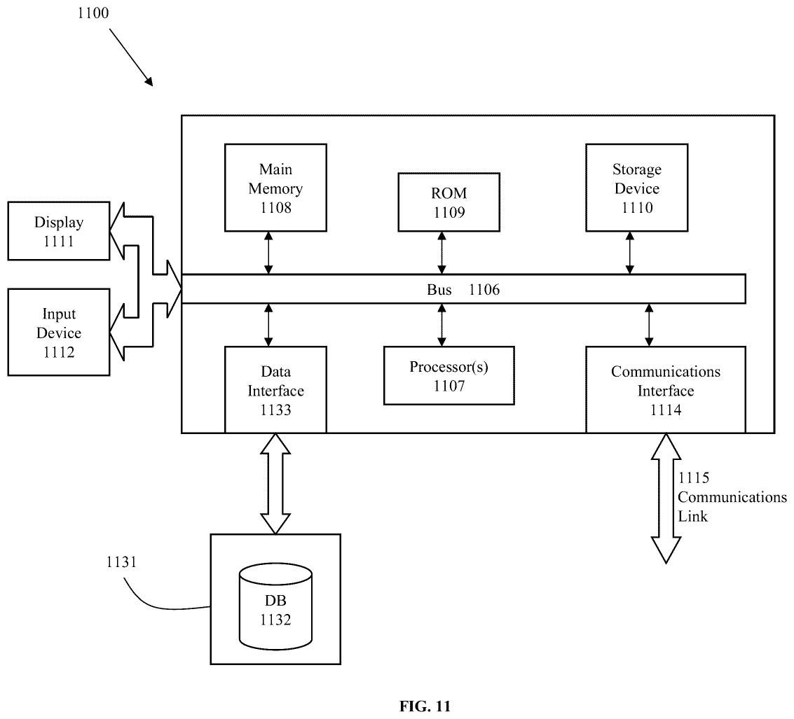

FIG. 11 is a block diagram of an illustrative computing system 1100 suitable for implementing an embodiment of the present invention. Computer system 1100 includes a bus 1106 or other communication mechanism for communicating information, which interconnects subsystems and devices, such as processor 1107, system memory 1108 (e.g., RAM), static storage device 1109 (e.g., ROM), disk drive 1110 (e.g., magnetic or optical), communication interface 1114 (e.g., modem or Ethernet card), display 1111 (e.g., CRT or LCD), input device 1112 (e.g., keyboard), and cursor control.

According to one embodiment of the invention, computer system 1100 performs specific operations by processor 1107 executing one or more sequences of one or more instructions contained in system memory 1108. Such instructions may be read into system memory 1108 from another computer readable/usable medium, such as static storage device 1109 or disk drive 1110. In alternative embodiments, hard-wired circuitry may be used in place of or in combination with software instructions to implement the invention. Thus, embodiments of the invention are not limited to any specific combination of hardware circuitry and/or software. In one embodiment, the term “logic” shall mean any combination of software or hardware that is used to implement all or part of the invention.

The term “computer readable medium” or “computer usable medium” as used herein refers to any medium that participates in providing instructions to processor 1107 for execution. Such a medium may take many forms, including but not limited to, non-volatile media and volatile media. Non-volatile media includes, for example, optical or magnetic disks, such as disk drive 1110. Volatile media includes dynamic memory, such as system memory 1108.

Common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, cloud-based storage, or any other medium from which a computer can read.

In an embodiment of the invention, execution of the sequences of instructions to practice the invention is performed by a single computer system 1100. According to other embodiments of the invention, two or more computer systems 1100 coupled by communication link 1115 (e.g., LAN, PTSN, or wireless network) may perform the sequence of instructions required to practice the invention in coordination with one another.

Computer system 1100 may transmit and receive messages, data, and instructions, including program, i.e., application code, through communication link 1115 and communication interface 1114. Received program code may be executed by processor 1107 as it is received, and/or stored in disk drive 1110, or other non-volatile storage for later execution. Data may be accessed from a database 1132 that is maintained in a storage device 1131, which is accessed using data interface 1133.

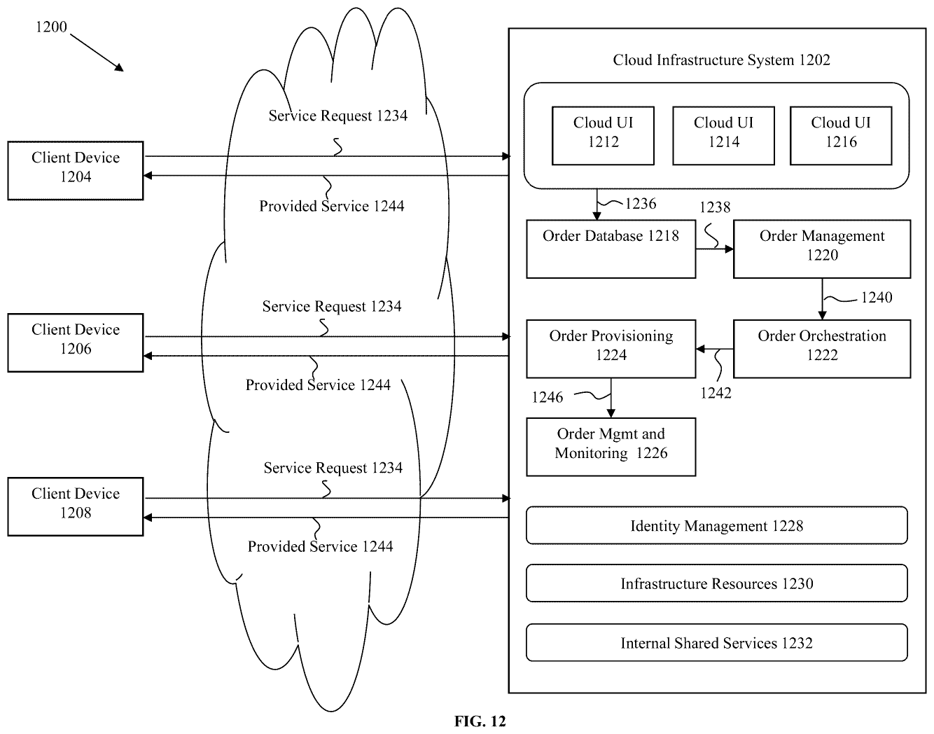

FIG. 12 is a simplified block diagram of one or more components of a system environment 1200 by which services provided by one or more components of an embodiment system may be offered as cloud services, in accordance with an embodiment of the present disclosure. In the illustrated embodiment, system environment 1200 includes one or more client computing devices 1204, 1206, and 1208 that may be used by users to interact with a cloud infrastructure system 1202 that provides cloud services. The client computing devices may be configured to operate a client application such as a web browser, a proprietary client application, or some other application, which may be used by a user of the client computing device to interact with cloud infrastructure system 1202 to use services provided by cloud infrastructure system 1202.

It should be appreciated that cloud infrastructure system 1202 depicted in the figure may have other components than those depicted. Further, the embodiment shown in the figure is only one example of a cloud infrastructure system that may incorporate an embodiment of the invention. In some other embodiments, cloud infrastructure system 1202 may have more or fewer components than shown in the figure, may combine two or more components, or may have a different configuration or arrangement of components.

Client computing devices 1204, 1206, and 1208 may be devices similar to those described above for FIG. 7. Although system environment 1200 is shown with three client computing devices, any number of client computing devices may be supported. Other devices such as devices with sensors, etc. may interact with cloud infrastructure system 1202.

Network(s) 1210 may facilitate communications and exchange of data between clients 1204, 1206, and 1208 and cloud infrastructure system 1202. Each network may be any type of network familiar to those skilled in the art that can support data communications using any of a variety of commercially available protocols. Cloud infrastructure system 1202 may comprise one or more computers and/or servers.

In certain embodiments, services provided by the cloud infrastructure system may include a host of services that are made available to users of the cloud infrastructure system on demand, such as online data storage and backup solutions, Web-based e-mail services, hosted office suites and document collaboration services, database processing, managed technical support services, and the like. Services provided by the cloud infrastructure system can dynamically scale to meet the needs of its users. A specific instantiation of a service provided by cloud infrastructure system is referred to herein as a “service instance.” In general, any service made available to a user via a communication network, such as the Internet, from a cloud service provider's system is referred to as a “cloud service.” Typically, in a public cloud environment, servers and systems that make up the cloud service provider's system are different from the customer's own on-premises servers and systems. For example, a cloud service provider's system may host an application, and a user may, via a communication network such as the Internet, on demand, order and use the application.

In some examples, a service in a computer network cloud infrastructure may include protected computer network access to storage, a hosted database, a hosted web server, a software application, or other service provided by a cloud vendor to a user, or as otherwise known in the art. For example, a service can include password-protected access to remote storage on the cloud through the Internet. As another example, a service can include a web service-based hosted relational database and a script-language middleware engine for private use by a networked developer. As another example, a service can include access to an email software application hosted on a cloud vendor's web site.

In certain embodiments, cloud infrastructure system 1202 may include a suite of applications, middleware, and database service offerings that are delivered to a customer in a self-service, subscription-based, elastically scalable, reliable, highly available, and secure manner.

In various embodiments, cloud infrastructure system 1202 may be adapted to automatically provision, manage and track a customer's subscription to services offered by cloud infrastructure system 1202. Cloud infrastructure system 1202 may provide the cloud services via different deployment models. For example, services may be provided under a public cloud model in which cloud infrastructure system 1202 is owned by an organization selling cloud services and the services are made available to the general public or different industry enterprises. As another example, services may be provided under a private cloud model in which cloud infrastructure system 1202 is operated solely for a single organization and may provide services for one or more entities within the organization. The cloud services may also be provided under a community cloud model in which cloud infrastructure system 1202 and the services provided by cloud infrastructure system 1202 are shared by several organizations in a related community. The cloud services may also be provided under a hybrid cloud model, which is a combination of two or more different models.

In some embodiments, the services provided by cloud infrastructure system 1202 may include one or more services provided under Software as a Service (SaaS) category, Platform as a Service (PaaS) category, Infrastructure as a Service (IaaS) category, or other categories of services including hybrid services. A customer, via a subscription order, may order one or more services provided by cloud infrastructure system 1202. Cloud infrastructure system 1202 then performs processing to provide the services in the customer's subscription order.

In some embodiments, the services provided by cloud infrastructure system 1202 may include, without limitation, application services, platform services and infrastructure services. In some examples, application services may be provided by the cloud infrastructure system via a SaaS platform. The SaaS platform may be configured to provide cloud services that fall under the SaaS category. For example, the SaaS platform may provide capabilities to build and deliver a suite of on-demand applications on an integrated development and deployment platform. The SaaS platform may manage and control the underlying software and infrastructure for providing the SaaS services. By utilizing the services provided by the SaaS platform, customers can utilize applications executing on the cloud infrastructure system. Customers can acquire the application services without the need for customers to purchase separate licenses and support. Various different SaaS services may be provided. Examples include, without limitation, services that provide solutions for sales performance management, enterprise integration, and business flexibility for large organizations.

In some embodiments, platform services may be provided by the cloud infrastructure system via a PaaS platform. The PaaS platform may be configured to provide cloud services that fall under the PaaS category. Examples of platform services may include without limitation services that enable organizations to consolidate existing applications on a shared, common architecture, as well as the ability to build new applications that leverage the shared services provided by the platform. The PaaS platform may manage and control the underlying software and infrastructure for providing the PaaS services. Customers can acquire the PaaS services provided by the cloud infrastructure system without the need for customers to purchase separate licenses and support.

By utilizing the services provided by the PaaS platform, customers can employ programming languages and tools supported by the cloud infrastructure system and control the deployed services. In some embodiments, platform services provided by the cloud infrastructure system may include database cloud services, middleware cloud services, and Java cloud services. In one embodiment, database cloud services may support shared service deployment models that enable organizations to pool database resources and offer customers a Database as a Service in the form of a database cloud. Middleware cloud services may provide a platform for customers to develop and deploy various business applications, and Java cloud services may provide a platform for customers to deploy Java applications, in the cloud infrastructure system.

Various different infrastructure services may be provided by an IaaS platform in the cloud infrastructure system. The infrastructure services facilitate the management and control of the underlying computing resources, such as storage, networks, and other fundamental computing resources for customers utilizing services provided by the SaaS platform and the PaaS platform.

In certain embodiments, cloud infrastructure system 1202 may also include infrastructure resources 1230 for providing the resources used to provide various services to customers of the cloud infrastructure system. In one embodiment, infrastructure resources 1230 may include pre-integrated and optimized combinations of hardware, such as servers, storage, and networking resources to execute the services provided by the PaaS platform and the SaaS platform.

In some embodiments, resources in cloud infrastructure system 1202 may be shared by multiple users and dynamically re-allocated per demand. Additionally, resources may be allocated to users in different time zones. For example, cloud infrastructure system 1230 may enable a first set of users in a first time zone to utilize resources of the cloud infrastructure system for a specified number of hours and then enable the re-allocation of the same resources to another set of users located in a different time zone, thereby maximizing the utilization of resources.

In certain embodiments, a number of internal shared services 1232 may be provided that are shared by different components or modules of cloud infrastructure system 1202 and by the services provided by cloud infrastructure system 1202. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

In certain embodiments, cloud infrastructure system 1202 may provide comprehensive management of cloud services (e.g., SaaS, PaaS, and IaaS services) in the cloud infrastructure system. In one embodiment, cloud management functionality may include capabilities for provisioning, managing, and tracking a customer's subscription received by cloud infrastructure system 1202, and the like.

In one embodiment, as depicted in the figure, cloud management functionality may be provided by one or more modules, such as an order management module 1220, an order orchestration module 1222, an order provisioning module 1224, an order management and monitoring module 1226, and an identity management module 1228. These modules may include or be provided using one or more computers and/or servers, which may be general purpose computers, specialized server computers, server farms, server clusters, or any other appropriate arrangement and/or combination.

In operation 1234, a customer using a client device, such as client device 1204, 1206 or 1208, may interact with cloud infrastructure system 1202 by requesting one or more services provided by cloud infrastructure system 1202 and placing an order for a subscription for one or more services offered by cloud infrastructure system 1202. In certain embodiments, the customer may access a cloud User Interface (UI), cloud UI 1212, cloud UI 1214 and/or cloud UI 1216 and place a subscription order via these Uis. The order information received by cloud infrastructure system 1202 in response to the customer placing an order may include information identifying the customer and one or more services offered by the cloud infrastructure system 1202 that the customer intends to subscribe to.

After an order has been placed by the customer, the order information is received via the cloud Uis, 1212, 1214 and/or 1216. At operation 1236, the order is stored in order database 1218. Order database 1218 can be one of several databases operated by cloud infrastructure system 1218 and operated in conjunction with other system elements. At operation 1238, the order information is forwarded to an order management module 1220. In some instances, order management module 1220 may be configured to perform billing and accounting functions related to the order, such as verifying the order, and upon verification, booking the order. At operation 1240, information regarding the order is communicated to an order orchestration module 1222. Order orchestration module 1222 may utilize the order information to orchestrate the provisioning of services and resources for the order placed by the customer. In some instances, order orchestration module 1222 may orchestrate the provisioning of resources to support the subscribed services using the services of order provisioning module 1224.

In certain embodiments, order orchestration module 1222 enables the management of business processes associated with each order and applies business logic to determine whether an order should proceed to provisioning. At operation 1242, upon receiving an order for a new subscription, order orchestration module 1222 sends a request to order provisioning module 1224 to allocate resources and configure those resources needed to fulfill the subscription order. Order provisioning module 1224 enables the allocation of resources for the services ordered by the customer. Order provisioning module 1224 provides a level of abstraction between the cloud services provided by cloud infrastructure system 1202 and the physical implementation layer that is used to provision the resources for providing the requested services. Order orchestration module 1222 may thus be isolated from implementation details, such as whether or not services and resources are provisioned on the fly or pre-provisioned and only allocated/assigned upon request.

At operation 1244, once the services and resources are provisioned, a notification of the provided service may be sent to customers on client devices 1204, 1206 and/or 1208 by order provisioning module 1224 of cloud infrastructure system 1202.

At operation 1246, the customer's subscription order may be managed and tracked by an order management and monitoring module 1226. In some instances, order management and monitoring module 1226 may be configured to collect usage statistics for the services in the subscription order, such as the amount of storage used, the amount data transferred, the number of users, and the amount of system up time and system down time.

In certain embodiments, cloud infrastructure system 1202 may include an identity management module 1228. Identity management module 1228 may be configured to provide identity services, such as access management and authorization services in cloud infrastructure system 1202. In some embodiments, identity management module 1228 may control information about customers who wish to utilize the services provided by cloud infrastructure system 1202. Such information can include information that authenticates the identities of such customers and information that describes which actions those customers are authorized to perform relative to various system resources (e.g., files, directories, applications, communication ports, memory segments, etc.) Identity management module 1228 may also include the management of descriptive information about each customer and about how and by whom that descriptive information can be accessed and modified.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are, accordingly, to be regarded in an illustrative rather than restrictive sense.

Additionally, the approach disclosed herein for adaptive throttling of storage service traffic within a client application addresses at least some of the issues of prior techniques suffer from, such as challenges introduced in cross network communication due to network isolation and access controls that do not allow public clouds or networks to initiate connections to private clouds or networks.

What is claimed is:

1. A computer-implemented method to manage access request frequency to resources with dynamically varying available capacity, comprising:
maintaining a computing cluster that accesses a storage service, wherein the storage service has limited capacity to service requests, and the limited capacity is shared among a plurality of clients that access the storage service;
monitor requests submitted to the storage service; and
adaptively throttling requests to the storage service based success or failure rates of the monitored requests submitted to the storage service.

2. The computer-implemented method of claim 1, wherein the plurality of clients in aggregate can send more requests to the storage service than the storage service can process at any given time.

3. The computer-implemented method of claim 1, wherein the storage service does not enforce a limit on a rate of requests a client can send to the storage service and does not reserve capacity for processing the same number of requests.

4. The computer-implemented method of claim 1, wherein the available capacity is determined for each container on the storage service.

5. The computer-implemented method of claim 1, wherein the computing cluster comprises a plurality of nodes, and one or more nodes determine an available capacity for the storage service to process requests to each container of one or more containers accessed by the one or more nodes.

6. The computer-implemented method of claim 5, wherein the computing cluster accesses multiple containers at the storage service and requests sent to the storage service are separately throttled for each container.

7. The computer-implemented method of claim 1, wherein the computing cluster uses a first container on the storage service for replication and disaster recovery operations and a second container on the storage service is used by a customer to load customer data.

8. A non-transitory computer readable medium having stored thereon a sequence of instructions which, when executed by a processor causes a set of acts to manage access request frequency to resources with dynamically varying available capacity, the set of acts comprising:
maintaining a computing cluster that accesses a storage service, wherein the storage service has limited capacity to service requests, and the limited capacity is shared among a plurality of clients that access the storage service;
monitor requests submitted to the storage service; and
adaptively throttling requests to the storage service based success or failure rates of the monitored requests submitted to the storage service.

9. The computer readable medium of claim 8, wherein the plurality of clients in aggregate can send more requests to the storage service than the storage service can process at any given time.

10. The computer readable medium of claim 8, wherein the storage service does not enforce a limit on a rate of requests a client can send to the storage service and does not reserve capacity for processing the same number of requests.

11. The computer readable medium of claim 8, wherein the available capacity is determined for each container on the storage service.

12. The computer readable medium of claim 8, wherein the computing cluster comprises a plurality of nodes, and one or more nodes determine an available capacity for the storage service to process requests to each container of one or more containers accessed by the one or more nodes.

13. The computer readable medium of claim 12, wherein the computing cluster accesses multiple containers at the storage service and requests sent to the storage service are separately throttled for each container.

14. The computer readable medium of claim 8, wherein the computing cluster uses a first container on the storage service for replication and disaster recovery operations and a second container on the storage service is used by a customer to load customer data.

15. A computing system comprising:
a memory to hold a set of instructions;
a computer processor to execute the set of instructions, which when executed cause a set of acts to resources with dynamically varying available capacity, the set of acts comprising:
maintaining a computing cluster that accesses a storage service, wherein the storage service has limited capacity to service requests, and the limited capacity is shared among a plurality of clients that access the storage service;
monitor requests submitted to the storage service; and
adaptively throttling requests to the storage service based success or failure rates of the monitored requests submitted to the storage service.

16. The computing system of claim 15, wherein the plurality of clients in aggregate can send more requests to the storage service than the storage service can process at any given time.

17. The computing system of claim 15, wherein the storage service does not enforce a limit on a rate of requests a client can send to the storage service and does not reserve capacity for processing the same number of requests.

18. The computing system of claim 15, wherein the available capacity is determined for each container on the storage service.

19. The computing system of claim 15, wherein the computing cluster comprises a plurality of nodes, and one or more nodes determine an available capacity for the storage service to process requests to each container of one or more containers accessed by the one or more nodes.

20. The computing system of claim 19, wherein the computing cluster accesses multiple containers at the storage service and requests sent to the storage service are separately throttled for each container.
